(19) United States
(12) Patent Application Publication
(10) Pub. No.: US 2016/0063448 A1
(43) Pub. Date: Mar. 3, 2016

(54) System and Method for Establishing an Open Communication Channel With an Advisor Via a Mobile Device

(71) Applicants: Stephen Jason Freeland, Los Feliz, CA (US); Burhan Khan, Brea, CA (US); Fred Roby, Chino Hills, CA (US)

(72) Inventors: Stephen Jason Freeland, Los Feliz, CA (US); Burhan Khan, Brea, CA (US); Fred Roby, Chino Hills, CA (US)

(21) Appl. No.: 14/469,990

(22) Filed: Aug. 27, 2014

(51) Int. Cl. G06Q 10/10; G06Q 20/32; G06Q 40/00

(52) U.S. Cl. CPC G06Q 10/1095; G06Q 40/00; G06Q 20/322

(57) ABSTRACT

A system is provided for establishing an open communication channel between a client and an advisor. The system includes a client device, an advisor device, and a host device, all connected via a network. If the client interacts with a “talk” portion of a mobile web site, the host will attempt to authorize the request by determining whether the client has sufficient funds in their account to cover a communication with the advisor for a predetermined period of time, where the predetermined period of time is either set by the host, an administer, or the advisor. If the host device determines that sufficient funds are available, the host device then determines whether the advisor is currently available. If the advisor is currently available, then the host will provide a phone number to the client device and update the advisor's queue to reflect the instant communication.

### BACKGROUND OF THE INVENTION

1. Field of the Invention

The present invention relates to a social network device, and more particularly, to a system and method for establishing an open communication channel between at least one first party (e.g., a client) and at least one second party (e.g., an advisor).

2. Description of Related Art

Every day, hundreds of millions of people communicate with each other over various networks. For example, some people communicate using telecommunication devices (e.g., cellular telephones, landlines, etc.) connected via telecommunication networks (e.g., satellites, telephone lines, fiber-optic lines, etc.), while others communicate using computers (e.g., smart phones, personal computers, etc.) connected via a wide area network, like the Internet. While most communications are direct communications, in that one party is communicating directly with another party (e.g., via a telephone call, an email, etc.), other communications are indirect, and involve at least one intermediary person or device. For example, there are hundreds, if not thousands of social networking sites whose primary purpose is to act as an intermediary, and connect (or introduce) one party to another. Examples of such social networking sites include Facebook™, Match.com™, and CaliforniaPsychics.com™.

Social networking sites generally include pay services, where services are paid for after services are rendered. For example, a typical social network site may introduce a first party to a second party, and then charge the first party (e.g., a third party bank account associated therewith) a per-minute rate for communicating with the second party. A typical psychic hotline is an example of a post-pay service, where the customer's credit card is charged after the call with the psychic is over, or after the amount due (which may be based on the length of the call) is known.

Other social network websites, however, may offer a prepaid service, or services where funds must be available in the user's website account before services are rendered. While a “prepaid service” has advantages, it also has certain drawbacks. For example, using the psychic business method as an example, in order to charge (or authorize) the customer before his/her call with the psychic, the system would need to know which psychic will be participating in the call, and a duration of the call. Thus, in order to offer prepaid psychic services, the social network site would need to (i) allow the customer to select a psychic, (ii) allow the customer to schedule a time for the communication, (iii) identify a duration of the call, and (iv) determine whether there are sufficient funds in the customer's account for the communication, all prior to the communication actually taking place.

In carrying out these steps, certain complications can arise, especially if the customer is interacting with the website via a mobile device, such as a traditional smartphone. This is because displays and keys on mobile devices are relatively small, making it difficult for a customer to interact (at least in detail) with a traditional website. For example, it may be difficult for a customer to search for a particular psychic, schedule a time and/or duration with the psychic, and add sufficient funds to their account to cover the scheduled communication.

Therefore, there is a need to develop a system and method that addresses the foregoing drawbacks and complications associated with prepaid (or preapproved) services, and assists customers in purchasing prepaid (or preapproved) services via a cellular telephone, or traditional smartphone. In particular, there is a need to develop a system and method for initiating an instant connection between a first party (e.g., a client, etc.) and a second party (e.g., an advisor, etc.). Such a system and method may identify the first party (e.g., using identifying information, etc.), allow the first party to conveniently identify a second party (e.g., using prior viewing or participation habits of the first party, etc.), and allow the first party a simple (e.g., one-touch) solution for instantaneously communicating with the second party.

### SUMMARY OF THE INVENTION

The present invention provides a system and method for establishing an open communication channel between a first party and a second party. Preferred embodiments of the present invention operate in accordance with at least one client device, at least one advisor device, and a host device, all connected via a network. In one embodiment of the present invention, a host device is used to establish an open communication channel between at least one client and at least one advisor. The advisor may use the advisor device to instruct the host device of the advisor's availability, the client may use the client device to initiate an instant communication with the advisor, and the host may use the advisor's queue and the client's account to authorize the instant communication.

In a preferred embodiment of the present invention, the client device is a mobile device, such as an Apple IPhone™ or Samsung Galaxy™. In accordance with this embodiment, the client uses the mobile device to perform functions that are typically performed using a computer (e.g., searching for an advisor, scheduling a communication with an advisor, etc.) and to perform functions that are typically performed using a telephone (e.g., participating in a communication with an advisor, etc.). The host then provides the client with a web page that has been modified for display on the mobile device (i.e., a mobile web page). This may be accomplished by either requesting the mobile web page from the host, or by the host recognizing the client device as a mobile device. In a preferred embodiment, the web page includes a plurality of interactive portions, such as a “schedule” portion and a “talk” portion. If the client interacts with the “schedule” portion, then the client may be provided with another mobile web page that allows the client to schedule a communication with the advisor. If the client interacts with the “talk” portion, then the host will attempt to authorize an instant communication between the client and the advisor.

In one embodiment of the present invention, the host is configured to authorize the instant communication between the client and the advisor by determining whether the client's online account (i.e., a website account) has “sufficient funds” to cover a predetermined period of time (or duration) with a particular advisor. In this embodiment, sufficient funds are calculated by multiplying the advisor's rate (e.g., per-minute-rate, etc.) with the predetermined period of time (e.g., 2 minutes, 10 minutes, etc.), which may either by set by the client, the host, an administer, or the advisor. If the host determines that sufficient funds are available, then the host will determine whether the advisor is currently available. If the host determines that the advisor is currently available, then the host will initiate a communication between the client and the advisor by providing a telephone number (e.g., a number associated with the communication) to the client's mobile device. The host will then update the advisor's queue to reflect the existing (or pending) communication.

In one embodiment of the present invention, if the client interacts with the “talk” portion of the mobile web page, and it is determined that the advisor is not available, then the client will be allowed to schedule a session with the advisor. To this end, the host may send to the mobile device a “pop-up,” or direct the device to a different web page, allowing the client to schedule a session (e.g., a start day, start time and/or duration) with the advisor. If the client interacts with the “talk” portion of the mobile web page, and it is determined that the client's account does not have sufficient funds, then the client will be allowed to add additional funds to their account. To this end, the host may send to the mobile device a pop-up, or direct the device to a different web page, allowing the client to add funds to their account.

A more complete understanding of a system and method for establishing an open communication channel between a first party and a second party will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1 illustrates an exemplary environment in which the present invention may operate, in which a host device communicates with a plurality of clients and a plurality of advisors;

FIG. 2 illustrates an exemplary environment in which the present invention may operate, in which a host device communicates with at least one client device and at least one advisor device via a network;

FIG. 3 illustrates a first embodiment of the present invention, in which a host device communicates with a first client device and a first advisory device over a network;

FIG. 4 illustrates a second embodiment of the present invention, in which a host device communicates with a second client device and a second advisory device over a network;

FIG. 4B illustrates a third embodiment of the present invention, in which a host device communicates with a third client device and a third advisory device over a network;

FIG. 5 illustrates a first mobile web page that a client may access when establishing a communication with an advisor;

FIG. 6 illustrates a first alert message superimposed over the first mobile web page shown in FIG. 5;

FIG. 7 illustrates a second alert message superimposed over the first mobile web page shown in FIG. 5;

FIG. 8 illustrates a second mobile web page that a client may access when purchasing a reading duration with an advisor;

FIG. 9 illustrate a method for establishing a connection between a client device (e.g., the third client device) and an advisory device in accordance with one embodiment of the present invention; and

FIG. 10 illustrates a method for purchasing a reading duration with an advisor in accordance with one embodiment of the present invention.

### DETAILED DESCRIPTION OF THE PREFERRED EMBODIMENT

The present invention provides a system and method for establishing an open communication channel between a first party (e.g., a customer, etc.) and a second party (e.g., a psychic, etc.). It should be appreciated that while the present application describes the invention in terms of a first party communicating with a second party, the present invention is not so limited. For example, the present invention could be used to establish and/or maintain an open communication channel between any client and any advisor (e.g., a financial advisor, spiritual advisor, psychic advisor, relationship advisor, medical advisor, etc.), or between more than two parties (e.g., a conference call, etc.).

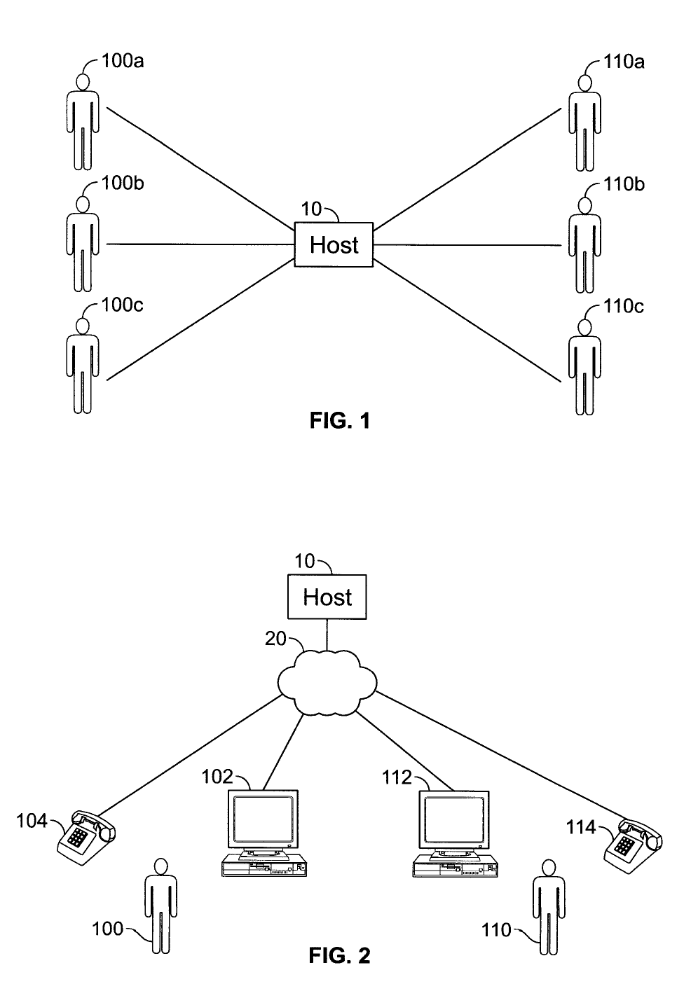

In a preferred embodiment of the present invention, as shown in FIG. 1, a host device 10 is used to establish an open communication channel between at least one of a plurality of clients (i.e., 100a, 100b, 100c, etc.) and at least one of a plurality of advisors (i.e., 110a, 110b, 110c, etc.). In one embodiment of the present invention, each client (e.g., 100a) interacts with the host device 10 to schedule, establish and/or participate in a communication between the client and at least one advisor (e.g., 110a, etc.). Such an interaction is shown in FIG. 2, where a particular client 100 is using a first and/or second client device 102, 104 to interact with the host device 10 via a network 20. Similarly, a particular advisor 110 may also use a first and/or second advisor device 112, 114 to interact with the host device 10 via a network 20. For example, the advisor 110 may use the first advisor device 112 to instruct the host device of the advisor's availability (e.g., by interacting with a web server portion of the host device), the client 100 may use the first client device 102 to schedule a communication with the advisor at a time that the advisor is available (e.g., by interacting with a web server portion of the host device), and the client 100 and advisor 110 may use the second client device 104 and the second advisor device 114, respectively, to participate in the scheduled communication.

It should be appreciated that while the first and second client devices 102, 104 and the first and second advisor devices 112, 114 are shown as a personal computer and a hardwired telephone, respectively, the present invention is not so limited. For example, a system that is configured to communicate with any telecommunication device, any computing device (e.g., a personal computer, a laptop, etc.), or any combination of the same (e.g., a “smart” cellular telephone (e.g., Apple IPhone™ Samsung Galaxy™, etc.), etc.) is within the spirit and scope of the present invention. It should also be appreciated that the network 20 shown in the figures is not limited to any particular network and can include, for example, any telecommunication network (e.g., satellite, telephone lines, fiber-optic lines, etc.), any wide area network (WAN) (e.g., the Internet), any local area network (LAN), or any combination thereof. For example, the client may be using a telephone, which is connected to a telecommunication network, to participate in the scheduled communication, and the advisor may be using a personal computer, which is connected to the Internet, to participate in the scheduled communication (e.g., via VOIP, etc.).

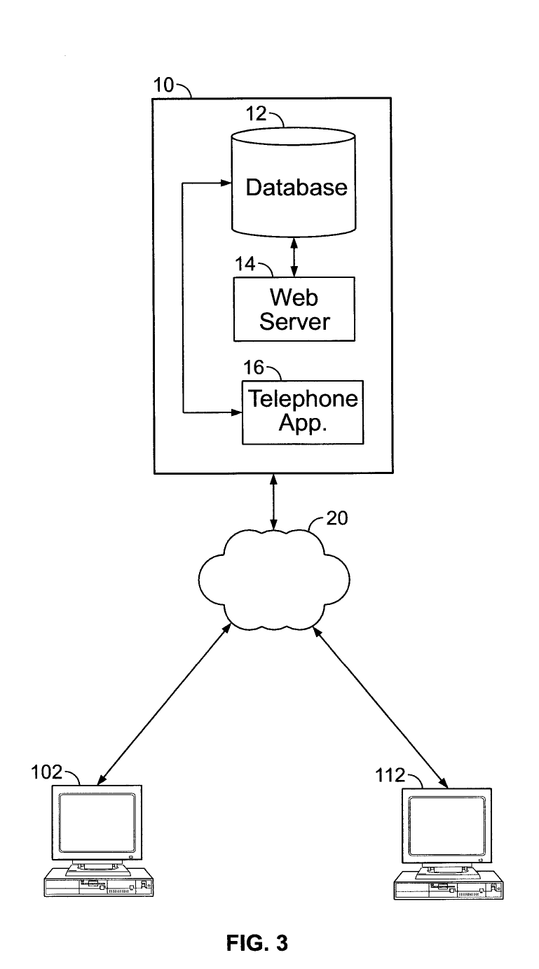

In accordance with a first embodiment of the present invention, as shown in FIG. 3, a client may use a first client device 102 to interact with the host 10 via the network 20. In a preferred embodiment, this is done by interacting with a web server 14, which is operating on the host device 10, in order to interact with a website. For example, by directing a web browser operating on the first client device 102 to a particular website, the client can be provided with an opening web page. An exemplary opening web page can be seen in FIG. 8 of Ser. No. 14/260,187 (“Related Application”), which was filed on Apr. 23, 2014, and is incorporated herein in its entirety by reference. As shown therein, such a web page may provide the client with a number of options, including the ability to search a list of participating advisors. It should be appreciated that the present invention is not limited to the features shown in FIG. 8 of the Related Application. For example, the opening web page may allow the client to login to the website (e.g., via user name and password), and to view a web page that has been personalized for the client (e.g., including features and/or advisors that have been selected by the client and/or selected by the system for the client). By way of another example, the opening web page may allow the advisor to login to the website (e.g., allowing the advisor to view scheduled communications, update their availability, and update their settings (e.g., pricing, etc.)). As with the client, the advisor can interact with the website via a web browser operating on the first advisor device (see FIG. 3 at 112). Information concerning the client and the advisor can be stored, for example, in a database (see FIG. 3 at 12).

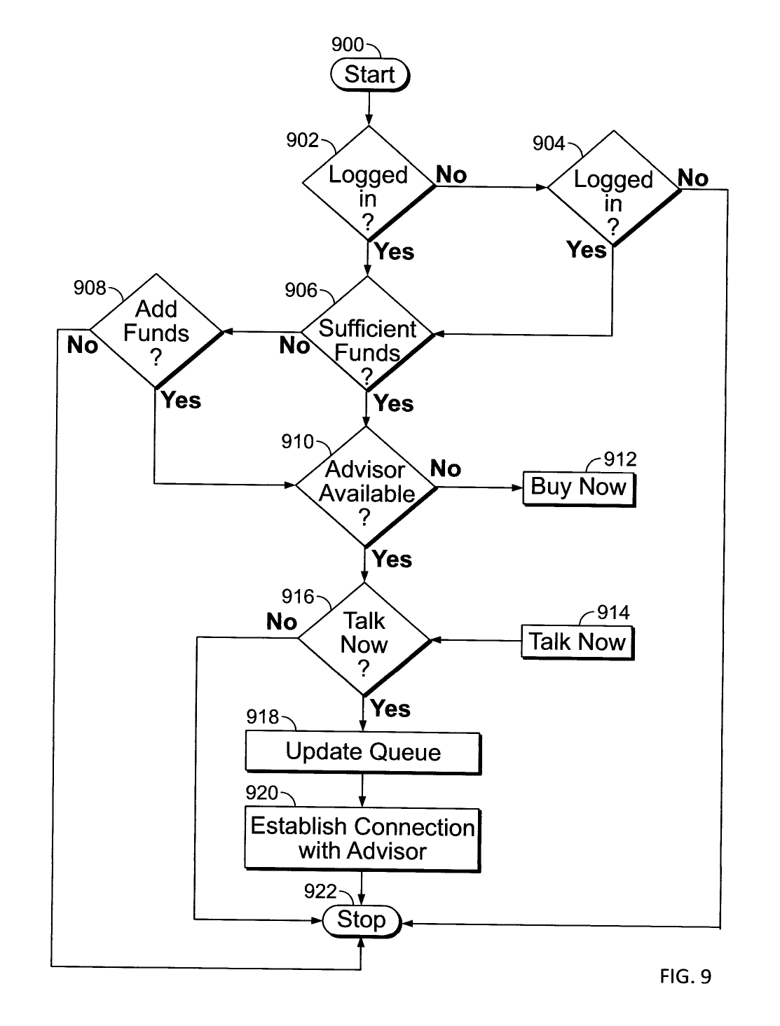

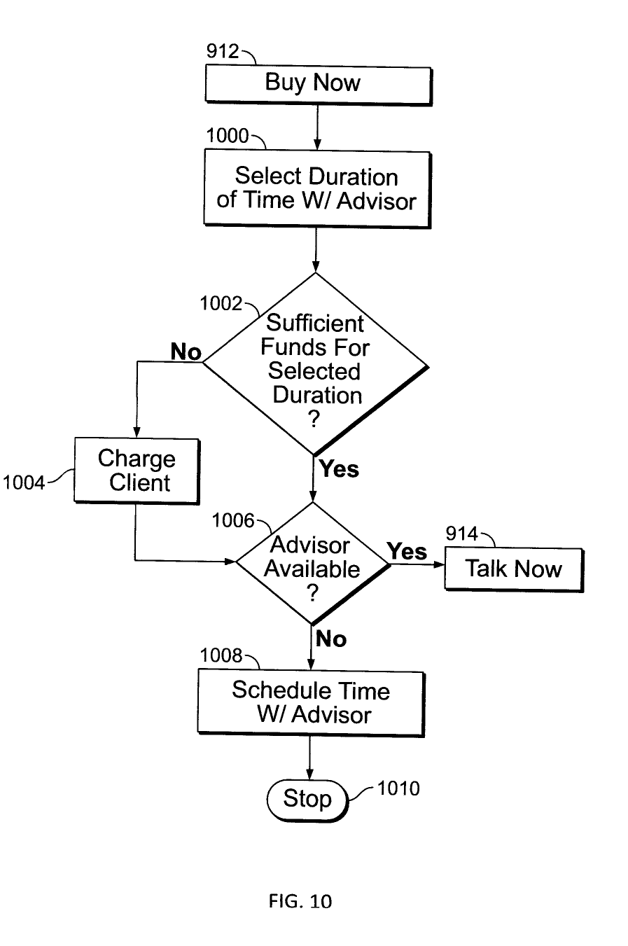

If the client chooses to search a list of participating advisors, the client may be presented with a list of participating advisors, as shown in FIG. 9 of the Related Application. The client may scroll through the list, or sort the list using a plurality of predefined fields (e.g., availability, alphabetically, price, recently added, customer favorites, staff picks, etc.). Once the client selects an advisor that they would like to communicate with (e.g., by “clicking” on the advisor), the client may be presented with additional information on the selected advisor, as shown in FIG. 10 of the Related Application. The client will then be allowed to schedule a communication with the selected advisor. For example, the client may choose from a list of preselected packages (e.g., preselected amounts, preselected durations, etc.). The client may then be provided with the option of participate in the communication by calling a predetermined telephone number, or having the system (or advisor) call them at a number to be provided by the client. The client can then view the schedule of the advisor, and select a day and time that is good for both the client and the advisor.

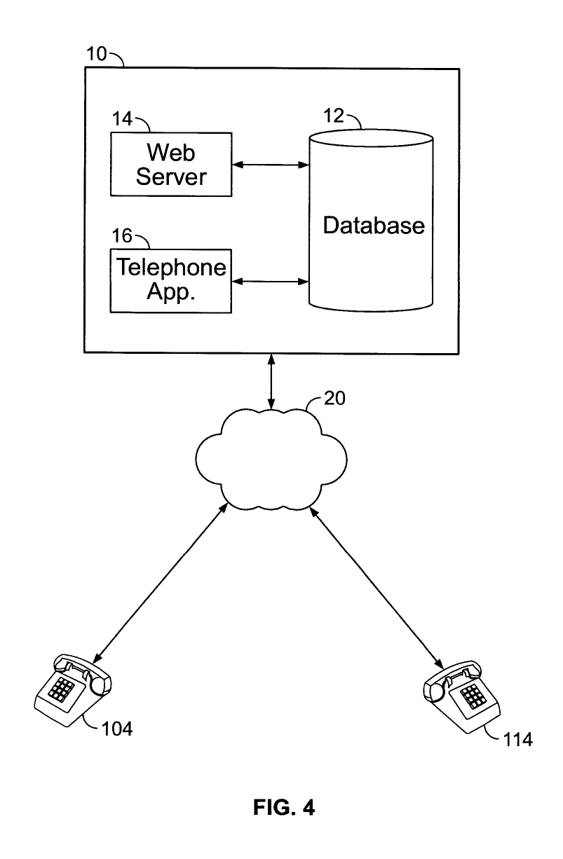

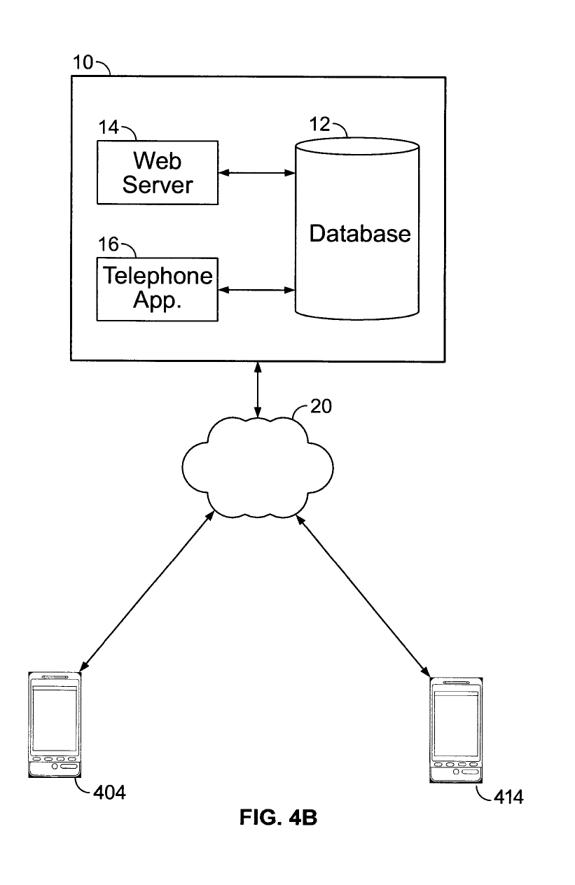

Once, the client has scheduled a communication, a client may participate in the communication via a telecommunication device, such as a telephone, as shown in FIG. 4. In one embodiment of the present invention, both the client and the advisor call a phone number (e.g., a 1-800 number) associated with the scheduled communication. The phone number may be assigned by the host device 10, and stored in the database 12. The host device 10 includes a telephone application 16 configured to assign and provide the phone number to the client and/or advisor, and may establish an open communication channel between the parties. For example, after the client and the advisor have called in, the telephone application may be configured to join the client and the advisor (e.g., via a telephony switch, etc.). Such a joinder may be similar to the joining of parties participating in a conference call, as generally known to those of ordinary skill in the art.

It should be appreciated that the present invention is not limited to the providing of a single phone number to both the client and the advisor. For example, a system that provides different phone numbers to the client and the advisor is within the spirit and scope of the present invention. A system that is configured to call the client and/or the advisor at the time of the scheduled communication is also within the spirit and scope of the present invention. For example, the advisor may call a telephone number associated with the scheduled communication, and the telephone application 16 may call the client at a number provided by the client, and join the advisor and the client once both of them are on the line. It should also be appreciated that present invention is not limited to communications involving telephones. For example, the two parties may be video chatting with one another, e.g., using computing devices and at least one multimedia application (e.g., like Skype).

As discussed above, one party may participate in a communication using a computing device, e.g., using VOIP or a smartphone. Such an embodiment can be seen in FIG. 4B, where both the client and the advisor are interacting with the web server 14 via smartphones 404, 414. In this embodiment, the client can use the smartphone 404 to perform functions that are typically performed using a computer (e.g., searching for an advisor, scheduling a communication with an advisor, etc.) and to perform functions that are typically performed using a telephone (e.g., participating in a communication with an advisor, etc.). Similarly, the advisor can use the smartphone 414 to perform functions that are typically performed using a computer (e.g., setting the advisor's availability, rate, minimum duration of a reading, etc.) and to perform functions that are typically performed using a telephone (e.g., participating in a communication with a client, etc.). It should be appreciated that the present invention is not limited to any particular embodiment, and combinations of the same are within the spirit and scope of the present invention. For example, the client may be using a smartphone to participate in a communication with the advisor, and the advisor may be using a traditional telephone to participate in a communication with the client.

If a client is interacting with the host (or an associated website) via a smartphone, the host may provide the client with a web page that has been modified for display on the smartphone (i.e., a mobile web page). The client may request the mobile web page from the host (e.g., by typing in the associated URL, by selecting it from a search result, etc.) or the host may provide the mobile web page to the client (e.g., after recognizing the client device as a smartphone, etc.).

An exemplary mobile web page is shown in FIG. 5. The mobile web page 500 may have an associated URL 510 and information on a particular advisor (e.g., rate 550, availability 540, etc.). The mobile web page may also include a plurality of interactive portions (e.g., soft keys, etc.) (e.g., a “schedule” portion 530, a “talk” portion 520, etc.). If the client interacts with (e.g., clicks on) the “schedule” portion 530, then the client may be provided with another mobile web page that allows the client to schedule a communication with the advisor (see, e.g., FIG. 8) (see also Related Application, FIG. 10 at 1030). Alternatively, the client can interact with (e.g., click on) the “talk” portion 520 to indicate a desire to immediately communicate with the advisor. It should be appreciated that the present invention is not limited to the mobile web page shown in FIG. 5. For example, web pages having different features (e.g., the ability to login (e.g., with user name and password), information on the client (e.g., their account balance, previously viewed advisors, previously communicated with advisors, etc.), etc.) are within the spirit and scope of the present invention.

In one embodiment of the present invention, if the client interacts with the “talk” portion 520 of the mobile web page 500, then the host 10 (e.g., via machine readable instructions stored in a database 12 or a separate storage device (not shown), etc.) may be configured to authorize an immediate communication with the advisor. In particular, the host 10 may be configured to determine whether the client's online account (i.e., a web account that is linked to the client's user name, etc.) has “sufficient funds.” In one embodiment of the present invention, sufficient funds are enough funds to cover a predetermined period of time (or duration) with a particular advisor. In this embodiment, sufficient funds are calculated by multiplying the advisor's rate (e.g., per-minute-rate, etc.) with the predetermined period of time (e.g., 2 minutes, 10 minutes, etc.), which may either by set by the client (e.g., a client-selected period of time), set by the host (e.g., a default period of time), set by an administer, or set by the advisor. By allowing an advisor to set their own period of time, the advisor is essentially selecting a minimum amount of funds that need to be available in the client's online account before the advisor will participate in an instant (or on-the-fly) communication with the client.

If the host determines that sufficient funds are available, then the host will determine whether the advisor is currently available (e.g., available at the time the client interacts with the “talk” portion). Such a determination may be based on whether the advisor is currently working (e.g., whether it is their day off), whether the advisor is currently occupied (e.g., participating in a session with another client), and/or whether the advisor has a session schedule in the near future (e.g., in the next two minutes, a default period of time, etc.). Determining whether the advisor is available may be based, at least in part, on whether the advisor's queue shows the advisor as being available. The advisor's queue may be stored in a database (see, e.g., FIG. 4B at 12) and may be modified by the host (e.g., based on a scheduled session, an existing (or pending) session, etc.), an administrator, and/or the advisor.

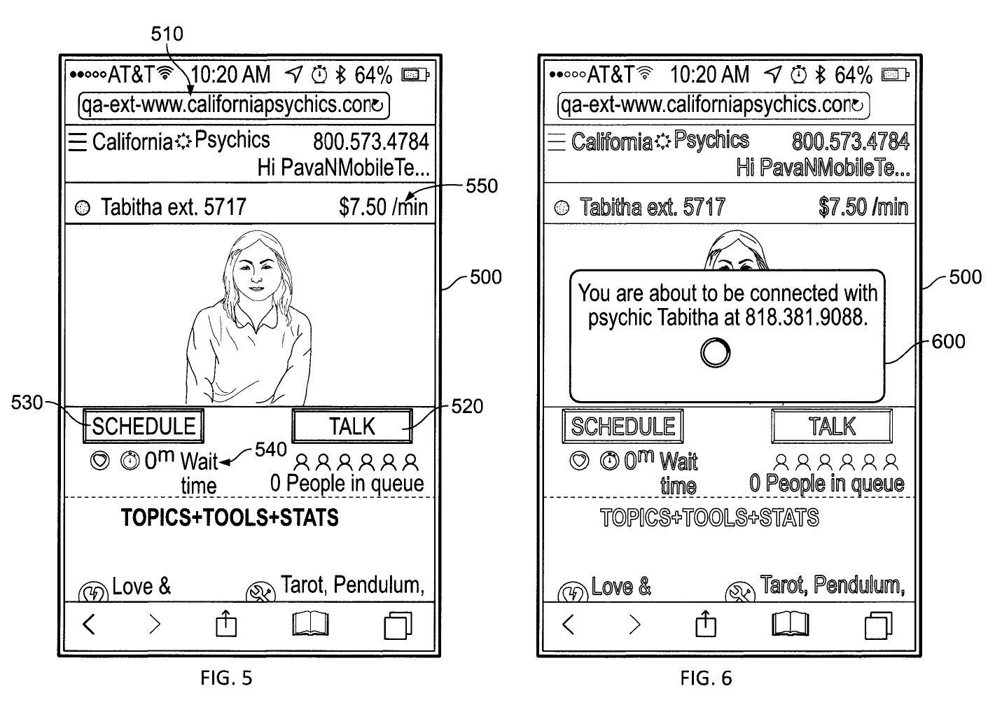

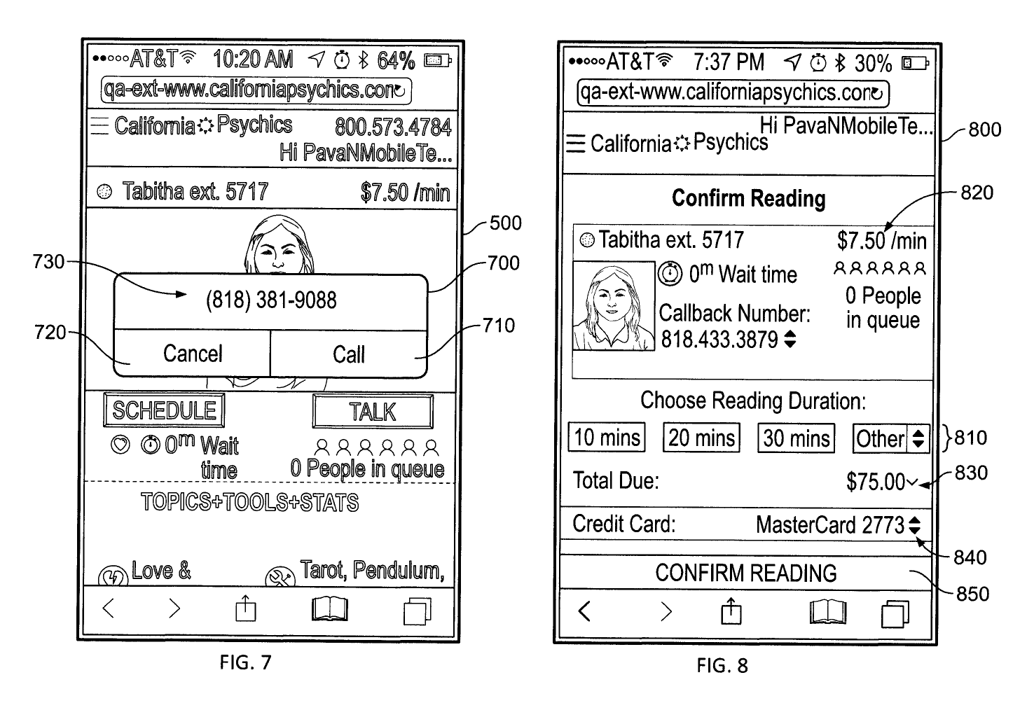

If the host determines that the advisor is currently available, then the host may initiate a communication between the client and the advisor. This may be accomplished, for example, by providing a telephone number (e.g., a number linked to the communication) to the client's device. If the client device is a smartphone, then the phone's native alert module may provide an alert to the client. A first example of such an alert can be seen in FIG. 6. In this example, the alert 600 is superimposed over the mobile web page 500 and informs the client that he/she is about to be connected to <the advisor> via <the phone number>. A second example of such an alert can be seen in FIG. 7. In this example, the alert 700 is also superimposed over the mobile web page 500 and (a) informs the client of <the phone number> 730 and (b) includes a plurality of portions, or soft keys (e.g., a “cancel” portion 720, a “call” portion 710, etc.). If the client interacts with (e.g., clicks on) the “cancel” portion 720, then the host will be notified that client has decided to terminate the communication, or the initiation thereof, and the advisor's queue will be updated (if necessary). If, however, the client interacts with the “call” portion 710, then the client is connected to the advisor (e.g., via the host, using the provided phone number, as discussed above), and allowed to participate in a communication with the advisor. The host may then update the advisor's queue to reflect the existing (or pending) session. The queue may then reflect that the advisor is either currently unavailable and/or will be unavailable for a predetermined period of time. In one embodiment of the invention, the predetermined period of time is set by the host and is either based on a default period of time (e.g., two minutes, etc.) or data on the client (e.g., funds that are in the client's account, an average (or typical) session duration for the client, etc.). In an alternate embodiment of the present invention, the host may provide the client device with a pop-up (or the like), allowing the client to select the predetermined period of time.

It should be appreciated that the present invention is not limited to the foregoing embodiment(s). For example, the host may be configured to update the advisor's queue upon interacting with the “talk” portion, interacting with the “call” portion, before the client's account is verified, after the client's account is verified, before the advisor's availability is verified, after the advisor's availability is verified, when the session starts, and/or when the session ends (indicating that the advisor is available). By way of another example, the present invention is not limited to the use of a native alert module, or alerts that are superimposed over a web page. It should also be appreciated that the present invention is not limited to the performance of steps in any particular order. Thus, for example, a host that determines whether the advisor is available before determining whether the client's account has sufficient funds is within the spirit and scope of the present invention.

With reference to FIG. 5, if the client interacts with the “talk” portion 520 of the mobile web page 500, and it is determined that the advisor is not available, then the client will be allowed to schedule a session with the advisor. To this end, the host may send to the smartphone, a “pop-up,” as generally known to those skilled in the art, allowing the client to schedule a session with the advisor. Alternatively, the host may send to the smart phone, or direct the smartphone to, a web page that allows the client to schedule a session with the advisor (see, e.g., Related Application at FIG. 10, Ref. No. 1030).

For example, as shown in FIG. 8, a web page 800, which shows the advisor's rate 820, and allows the client to select a particular duration 810 for the session or communication. The particular duration 810 is then multiplied by the rate 820, and the total 830 is presented to the client. A determination is then made as to whether there are enough funds in the client's account to cover the session. If the answer is NO, then the client is allowed to add funds to their account (e.g., via a credit card on file 840, PayPal™, etc.). It should be appreciated that the present invention is not limited to the web page shown in FIG. 8. For example, the web page may allow the user to select a particular package (or associated dollar amount) to add to their account, instead of a duration, which must then be multiplied by the advisor's rate. Once the client has added funds to their account, or if there are sufficient funds in their account, then they can then interact with a “confirm reading” portion 850. In response thereto, the host may either present the client's device with the mobile web page 500 (see FIG. 5), allowing the client to interact with the “talk” portion, or treat the “confirm reading” interaction as if the client had interacted with the “talk” portion (e.g., determining sufficient funds, determining availability, and/or providing a phone number to the client device). In an alternate embodiment of the present invention, FIG. 8 may also allow the client to schedule a session (e.g., start day, start time, and/or duration) with the advisor (see, e.g., Related Application, FIG. 10 at 1030) prior to interacting with the “confirm reading” portion.

If the client interacts with the “talk” portion 520 of the mobile web page 500, and it is determined that the client's account does not have sufficient funds, then the client will be allowed to add additional funds to their account. To this end, the host may send to the smartphone, or direct the smart phone to, a web page that allows the client to add funds to their account (not shown). Alternatively, the host may allow the client to add funds to their account (e.g., funds necessary to participate in a communication with the advisor for a predetermined duration of time) via a “pop-up,” as generally known to those skilled in the art (not shown). Is should be appreciated that while the foregoing web page or pop-up may allow a user to add a user-selected amount of funds (or funds for a user-selected period of time with the advisor) to their account, it may also provide the client with a simple request (or authorization) to add to the client's account a predetermined amount of funds or an amount of funds for a predetermined period of time with the advisor. For example, a pop-up may ask the client if he/she would like to add $75.00 to their account to cover ten minutes of time with the advisor, whose rate is $7.50 per minute. By way of another example, if the client's online account has a balance of $10.00 (or $10.00 worth of credits), a pop-up may ask the client if he/she would like to add $65.00 to their account, in order to put sufficient funds in the client's account to cover ten minutes with the advisor, whose rate is $7.50 per minute.

A method of establishing a connection in accordance with one embodiment of the present invention is shown in FIG. 9. Starting at step 900, if a client requests to be instantly connected to a particular advisor (e.g., by clicking on the “talk” portion of the mobile web page), then it is determined whether the client is logged in at step 902. If the answer is NO, then the client may be provided with a login web page (or pop-up) at step 904, which allows the client to provide a user name and password associated with the client's account. If the answer is YES, or the client logs in at step 904, then a determination is made as to whether the client's account has sufficient funds, or enough funds to participate in a communication (or session) with the advisor for a particular duration of time at step 906. For example, if the advisor's rate is $7.50 per minute, then a determination may be made as to whether the client's account has $7.50 in it (i.e., enough funds to cover one minute with the advisor). It should be appreciated that the present invention is not limited to a particular “period of time,” and all periods of time, which can be set by the client, the website, an administrator of the website, or the advisor, is within the spirit and scope of the present invention. If the answer to step 906 is YES, then a determination is made as to whether the advisor is currently available at step 910. If the answer to step 906 is NO, then the client may be provided with a web page (or pop-up) at step 908, which allows the client to add funds to their account.

If it is determined at step 910 that the advisor is not available, then the client may be provided with a web page (or pop-up) at step 912, which allows the client to schedule a communication (or session) with the advisor (e.g., a start day, a start time, and/or a duration). However, if the advisor is currently available (e.g., available when the client starts the foregoing process), then a phone number associated with the communication (or session) is provided to the client's device (e.g., smartphone, etc.), and a determination is made (e.g., by the device) as to whether the client would like to dial the telephone number at step 916. If the answer is NO, then the process ends at step 922. However, if the answer is YES, then the advisor's queue is updated (e.g., indicating that the advisor is currently unavailable, unavailable for a predetermined period of time, etc.) at step 918. The host system then connects the client with the advisor at step 920, ending the process at step 922.

It should be appreciated that the present invention is not limited to the method shown in FIG. 9, and that methods involving fewer, more, or differently ordered steps are within the spirit and scope of the present invention. For example, the system may be configured to update the advisor's queue (e.g., showing the advisor as busy and/or with the client) at any time during the method. By way of another example, if it is determined that the advisor is available at step 910, then the advisor's queue may be updated at step 918 and a connection may be established at step 920, thereby excluding step 916 from the method. By way of another example, the system may be configured to perform the determination step of 910 before the determination step of 906. By way of another example, the method may not allow the client to request an instant connection with an advisor until the client has logged in, or the system identifies the client using the phone number of the client device, or the IP address or other identifying information of the client's device (assuming this information is linked to the client's account). It should be appreciated that using any information to identify the client (or client device) may require the entry of a PIN, password, or other confirming data.

A method of scheduling a communication (e.g., start day, start time, and/or duration) with an advisor is shown in FIG. 10. Starting at step 912, the client is allowed to select a period of time for the communication at step 1000. A determination is then made as to whether the client has sufficient funds in their account to cover the selected duration of time with the advisor at step 1002. For example, if the advisor's rate is $7.50 a minute, and a 10 minute duration of time is selected, then a determination is made as to whether the client's account has at least $75.00. If the answer is NO, then the client is allowed to add funds to their account at step 1004. If the answer is YES, then a determination is made as to the advisor's availability at step 1006. If the advisor is currently unavailable, then the client is allowed to schedule a day, time and/or duration for the communication with the advisor at step 1008, ending the method at step 1010. However, if the advisor is currently available, then a phone number associated with the communication is provided to the client's device (e.g., smartphone, etc.), and a determination is made (e.g., by the device) as to whether the client would like to dial the telephone number at step 916 (see FIG. 9). The method would then continue as previously described. It should be appreciated that the present invention is not limited to the method shown in FIG. 10, and that methods involving fewer, more, or differently ordered steps are within the spirit and scope of the present invention. For example, a method where (i) the duration is selected by the host, an administrator, or the advisor, and (ii) the host determines whether there are sufficient funds in the client's online account (either before or after the advisor's availability is determined) is within the spirit and scope of the present invention. It should also be appreciated that the foregoing method (or a method of scheduling a communication with an advisor) may commence manually, with the user requesting to schedule a communication with the advisor, or automatically (e.g., in response to an advisor being unavailable).

It should be appreciated that the systems and methods described herein are generally described as “pre-paid” systems, in that sufficient funds must be in a client's account before the client is allowed to participate in a communication with an advisor. As described above, a client may request an immediate connection with an advisor, or a client may request a scheduled session with an advisor at a selected day/time and/or for a selected period of time. In both instances, the system is configured to determine whether there are sufficient funds in the client's account for the communication. In the prior, sufficient funds are funds necessary for a communication with the advisor for a predetermined period of time (e.g., two minutes, etc.). In the latter, sufficient funds are either (i) funds necessary for a communication with the advisor for the selected period of time or (ii) funds necessary for a communication with the advisor for a predetermined period of time (e.g., two minutes, etc.). It should be appreciated, however, that in all instances, the client is only charged for the period of time that the client actual communicates with the advisor. Thus, for example, if the client schedules a communication for ten minutes, but ends the communication after eight minutes, the client is only charged for eight minutes. Similarly, if the client requests an immediate connection with an advisor, and the client continues the communication for longer than the predetermined period of time (e.g., longer than two minutes, longer than the time pre-authorized, etc.), than the system may periodically determine whether the client has sufficient funds (e.g., money, credits, etc.) in his account for additional periods of time (e.g., an additional two minutes, a total communication of four minutes, etc.). If the system determines that the client does not have sufficient funds for additional time, the system may inform the client of the insufficiency, and the client may have the opportunity to add additional funds to his/her account during the communication. See, e.g., Related Application, FIG. 7. The system may also terminate the call if the client's account has insufficient funds for additional time.

The foregoing description of a system and method for establishing an open communication channel between a first party and a second party has been presented for the purposes of illustration and description. It is not intended to be exhaustive or to limit the invention to the precise forms disclosed, and many modifications and variations are possible in light of the above teachings. Those skilled in the art will appreciate that there are a number of ways to implement the foregoing features, and that the present invention it not limited to any particular way of implementing these features. The invention is solely defined by the following claims.

What is claimed is:

1. A method for establishing a connection between a client and an advisor, comprising:
providing by a server a web page to a mobile device that includes at least a first portion for initiating an open communication channel between said mobile device and an advisor device;
determining by at least one program operating on said server and in response to said interaction with said first portion of said web page (i) whether an account linked to said client has an existing amount of money that is one of equal to and greater than a first amount of money, said first amount of money being equal to a rate associated with said advisor multiplied by a first predetermined duration of time, and (ii) whether said advisor is currently available;
establishing by said server an open communication channel between said mobile device and said advisor device when it is determined that (i) said existing amount of money is one of equal to and greater than said first amount of money and (ii) said advisor is currently available;
providing by said server second web-page content to said mobile device when it is determined that said existing amount of money is less than said first amount of money, said second web-page content allowing said client to add money to said account; and
providing by said server third web-page content to said mobile device when it is determined that said advisor is not currently available, said third web-page content allowing said client to schedule a session between said client and said advisor.

2. The method of claim 1, wherein said at least one program further determines whether said client is logged into said server before at least determining whether said existing amount is one of equal to and greater than said first amount of money.

3. The method of claim 1, further comprising the step of selecting by said advisor said first predetermined duration of time and storing said first predetermined duration of time in a database in communication with said server.

4. The method of claim 1, wherein said step of establishing an open communication channel between said mobile device and said advisor device further comprises providing a telephone number to said mobile device, wherein said mobile device's native alert module displays said telephone number to said client prior to dialing said telephone.

5. The method of claim 1, further comprising reserving said advisor for a second predetermined duration of time, said second predetermined duration of time being stored in a database in communication with said server.

6. The method of claim 1, wherein second web-page content is provided to said mobile device via a pop-up window, which is superimposed over said mobile web page.

7. The method of claim 5, wherein said second predetermined duration of time is equal to said first predetermined duration of time.

8. The method of claim 1, wherein said second web-page content includes a plurality of portions, wherein each portion can be interacted with by said client to purchase a different duration of time with said advisor.

9. A system for establishing a connection between a client and an advisor, comprising:
a computing system in communication with at least one network and comprising at least one memory device for storing machine readable instructions adapted to perform the steps of:
providing a web page to a mobile device that includes at least a first portion for initiating an open communication channel between said mobile device and an advisor device;
determining in response to said interaction with said first portion of said web page (i) whether an account linked to said client has an amount of money that is at least one of one of equal to and greater than a first amount of money, said first amount of money being equal to a rate associated with said advisor multiplied by a first predetermined duration of time, an (ii) whether said advisor is available at said time of said interaction;
establishing by said server an open communication channel between said mobile device and said advisor device when it is determined that (i) said amount of money in said account is at least one of equal to and greater than said first amount of money and (ii) said advisor is available at said time of said interaction;
providing second web-page content to said mobile device when it is determined that said amount of money in said account is less than said first amount of money, said second web-page content allowing said client to add money to said account; and
providing third web-page content to said mobile device when it is determined that said advisor is not available at said time of said interaction, said third web-page content allowing said client to schedule a future communication between said client and said advisor.

10. The system of claim 9, wherein said machine readable instructions are further adapted to identify said client before at least determining whether said amount of money in said account is at least one of equal to and greater than said first amount of money.

11. The system of claim 9, wherein said machine readable instructions are further adapted to receive said first predetermined duration of time from said advisor, said first predetermined duration of time being stored in a database portion of said computing system.

12. The system of claim 9, wherein said step of establishing an open communication channel between said mobile device and said advisor device further comprises providing a telephone number to said mobile device, wherein said mobile device uses said telephone number to initiate said open communication channel.

13. The system of claim 9, wherein said machine readable instructions are further adapted to reserve said advisor for a second predetermined duration of time, thereby preventing another client from reserving said advisor during said second predetermined duration of time.

14. The system of claim 10, wherein said machine readable instructions are further adapted to identify said client by matching information provided by said mobile device to said client's account, said information being at least one of a telephone number of said mobile device, and IP address of said mobile device, and an identification number stored on said mobile device.

15. The system of claim 13, wherein said first predetermined duration of time is less than said first predetermined duration of time.

16. The system of claim 9, wherein said second web-page content includes a plurality of portions, wherein each portion can be interacted with by said client to purchase a different duration of time with said advisor.

17. A method for establishing a connection between a client and an advisor, comprising:
receiving from said client device identifying information, said identifying information being linked to an account associated with said client;
providing by said computing system a first web page to said client device that includes at least rate information on said advisor, said advisor being one of a plurality of advisors stored in said computing system;
allowing said client to initiate said connection between said client and said advisor by interacting with a predetermined portion of said first web page;
providing by said computing system a telephone number associated with said connection to said client device when (i) said account includes sufficient funds to cover a communication with said advisor for a first duration of time, and (ii) said advisor is available at a time of said interaction with said predetermined portion of said first web page;
providing by said computing system second web-page content to said client device when said account includes funds that are insufficient to cover said communication with said advisor for said first duration of time, said second web-page content allowing said client to add funds to said account; and
providing by said computing system third web-page content to said client device when said advisor is not available at said time of said interaction with said predetermined portion of said first web page, said third web-page content allowing said client to schedule a future communication with said advisor.

18. The method of claim 17, further comprising the step of receiving from said advisor said first duration of time and said rate, thereby allowing said advisor to select an amount of money that needs to be available in said account in order to establish said connection in response to said client interacting with said predetermined portion of said first web page.

19. The method of claim 17, wherein said step of receiving from said client device identifying information further comprises receiving user name and password information.

20. The method of claim 17, wherein said step of receiving from said client device identifying information further comprises receiving at least one of a telephone number of said mobile device, and IP address of said mobile device, and an identification number stored on said mobile device.
